(19) United States
(12) Patent Application Publication
(10) Pub. No.: US 2026/0097694 A1
(43) Pub. Date: Apr. 9, 2026

(54) FLEXIBLE COMPOSITE SHEET AND FLEXIBLE SEAT CUSHION INCLUDING THE SAME

(71) Applicant: Wen-Yuan SU, Taipei City (TW)

(72) Inventor: Wen-Yuan SU, Taipei City (TW)

(21) Appl. No.: 19/348,383

(22) Filed: Oct. 2, 2025

(30) Foreign Application Priority Data
Oct. 7, 2024 (TW) 113138107

(51) Int. Cl. B60N 2/64; B32B 5/02; B32B 5/18; B32B 5/24; B32B 15/082; B32B 15/14

(52) U.S. Cl. CPC B60N 2/64; B32B 5/02; B32B 5/18; B32B 5/245; B32B 15/082; B32B 15/14; B32B 2250/04; B32B 2307/402; B32B 2307/412; B32B 2307/7376; B32B 2601/00

(57) ABSTRACT

A flexible composite sheet includes a flexible polymer film and a metal film. The flexible polymer film is obtained by loading a masterbatch composition to develop color in a flexible polymer substrate. The masterbatch composition includes a thermoplastic polymer and a pigment component. The metal film is in intimate contact with a surface of the flexible polymer film. The flexible composite sheet has low heat build-up property. A flexible seat cushion including a foam layer, a base fabric, and the flexible composite sheet is also provided.

### CROSS-REFERENCE TO RELATED APPLICATION

This application claims priority to Taiwanese Invention Patent Application No. 113138107, filed on Oct. 7, 2024, the entire disclosure of which is incorporated by reference herein.

### FIELD

The disclosure relates to a composite sheet, and more particularly to a flexible composite sheet which has low heat build-up property, and a flexible seat cushion including the flexible composite sheet.

### BACKGROUND

Conventional fabric materials used as the surfaces of seat cushions in bicycles, motorcycles, yachts, vehicles, buses, and other means of transportation are generally flexible plastics, such as polyvinyl chloride (PVC), polypropylene (PP), polyurethane (PU), polyethylene terephthalate (PET), nylon, etc. In order to reduce the degree of visible dirt and surface reflection, the surfaces of the seat cushions are often configured in dark colors. For instance, carbon black, which is readily obtainable and commonly used as pigment, may be incorporated into a plastic. Although use of the carbon black can reduce the degree of visible dirt, a drawback thereof is that the carbon black readily absorbs infrared radiation, causing the seat cushions to undergo a significant temperature rise and to prevent the temperature from easily decreasing thereafter. In recent years, as summer weather becomes increasingly hot, a demand for seat cushions with low heat build-up property has become more important. When the surfaces of seat cushions are configured in light colors (particularly white), a heat build-up effect resulted from absorption of infrared radiation can be effectively reduced; however, the degree of visible dirt can hardly be suppressed.

TW 1509038 B discloses a pigment composition having low heat build-up property under infrared radiation, and a material including the pigment composition. By virtue of the pigment composition obtained by selecting several specific pigments and subsequently combining the selected pigments, the material containing the pigment composition is capable of reducing heat build-up resulted from absorption of infrared radiation. However, the reduction in heat build-up achieved by the pigment composition disclosed in TW 1509038 B still leaves room for further improvement.

In view of the aforesaid, there is still a need to develop a pigment-containing material that can be used to prepare a seat cushion with low heat build-up property.

### SUMMARY

Therefore, in a first aspect, the present disclosure provides a flexible composite sheet, which can alleviate at least one of the drawbacks of the prior art. The flexible composite sheet includes a flexible polymer film and a metal film. The flexible polymer film is obtained by loading a masterbatch composition to develop color in a flexible polymer substrate. The masterbatch composition includes a thermoplastic polymer, a yellow pigment component, a red pigment component, and a blue pigment component. The yellow pigment component is selected from the group consisting of Color Index (C.I.) Pigment Yellow 81, C.I. Pigment Yellow 83, C.I. Pigment Yellow 109, C.I. Pigment Yellow 110, C.I. Pigment Yellow 120, C.I. Pigment Yellow 128, C.I. Pigment Yellow 138, C.I. Pigment Yellow 147, C.I. Pigment Yellow 181, C.I. Pigment Yellow 183, C.I. Pigment Yellow 214, C.I. Pigment Brown 23, and combinations thereof. The red pigment component is selected from the group consisting of C.I. Pigment Red 122, C.I. Pigment Red 144, C.I. Pigment Red 149, C.I. Pigment Red 166, C.I. Pigment Red 181, C.I. Pigment Red 202, C.I. Pigment Red 214, C.I. Pigment Red 221, C.I. Pigment Red 242, C.I. Pigment Red 254, C.I. Pigment Red 262, C.I. Pigment Orange 43, C.I. Pigment Orange 61, C.I. Pigment Orange 64, C.I. Pigment Orange 68, C.I. Pigment Orange 72, C.I. Pigment Violet 19, C.I. Pigment Violet 37, C.I. Pigment Violet 23, and combinations thereof. The blue pigment component is selected from the group consisting of C.I. Pigment Blue 15 series, C.I. Pigment Blue 16, C.I. Pigment Blue 60, C.I. Pigment Blue 80, and combinations thereof. The metal film is in intimate contact with a surface of the flexible polymer film. The flexible composite sheet has low heat build-up property.

In a second aspect, the present disclosure provides a flexible seat cushion, which can alleviate at least one of the drawbacks of the prior art. The flexible seat cushion includes a foam layer, a base fabric, and the aforesaid flexible composite sheet. The base fabric tightly covers a surface of the foam layer. A surface of the metal film opposite to the flexible polymer film in the aforesaid flexible composite sheet is in intimate contact with a surface of the base fabric opposite to the foam layer.

In a third aspect, the present disclosure provides another flexible composite sheet, which can alleviate at least one of the drawbacks of the prior art. The flexible composite sheet includes a flexible polymer film and a metal film. The flexible polymer film is obtained by loading a masterbatch composition to develop color in a flexible polymer substrate. The masterbatch composition includes a thermoplastic polymer and a black pigment component. The black pigment component is selected from the group consisting of Color Index (C.I.) Pigment Black 31, C.I. Pigment Black 32, and a combination thereof. The metal film is in intimate contact with a surface of the flexible polymer film. The flexible composite sheet has low heat build-up property.

In a fourth aspect, the present disclosure provides another flexible seat cushion, which can alleviate at least one of the drawbacks of the prior art. The flexible seat cushion includes a foam layer, a base fabric, and the aforesaid another flexible composite sheet. The base fabric tightly covers a surface of the foam layer. A surface of the metal film opposite to the flexible polymer film in the aforesaid another flexible composite sheet is in intimate contact with a surface of the base fabric opposite to the foam layer.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic sectional view illustrating an embodiment of a flexible composite sheet according to the present disclosure.

FIG. 2 is a schematic sectional view illustrating an embodiment of a flexible seat cushion according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

### <First Embodiment of Flexible Composite Sheet>

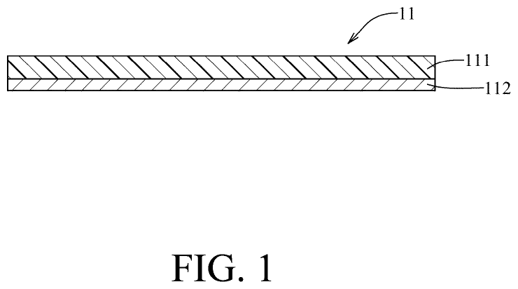

Referring to FIG. 1, a first embodiment of a flexible composite sheet 11 according to the present disclosure includes a flexible polymer film 111 and a metal film 112. The flexible polymer film 111 is obtained by loading a masterbatch composition to develop color in a flexible polymer substrate. The masterbatch composition includes a thermoplastic polymer and a pigment component containing a yellow pigment component, a red pigment component, and a blue pigment component. The metal film 112 is in intimate contact with a surface of the flexible polymer film 111. The first embodiment of the flexible composite sheet 11 has low heat build-up property.

According to the present disclosure, the yellow pigment component is selected from the group consisting of Color Index (C.I.) Pigment Yellow 81, C.I. Pigment Yellow 83, C.I. Pigment Yellow 109, C.I. Pigment Yellow 110, C.I. Pigment Yellow 120, C.I. Pigment Yellow 128, C.I. Pigment Yellow 138, C.I. Pigment Yellow 147, C.I. Pigment Yellow 181, C.I. Pigment Yellow 183, C.I. Pigment Yellow 214, C.I. Pigment Brown 23, and combinations thereof. The red pigment component is selected from the group consisting of C.I. Pigment Red 122, C.I. Pigment Red 144, C.I. Pigment Red 149, C.I. Pigment Red 166, C.I. Pigment Red 181, C.I. Pigment Red 202, C.I. Pigment Red 214, C.I. Pigment Red 221, C.I. Pigment Red 242, C.I. Pigment Red 254, C.I. Pigment Red 262, C.I. Pigment Orange 43, C.I. Pigment Orange 61, C.I. Pigment Orange 64, C.I. Pigment Orange 68, C.I. Pigment Orange 72, C.I. Pigment Violet 19, C.I. Pigment Violet 37, C.I. Pigment Violet 23, and combinations thereof. The blue pigment component is selected from the group consisting of C.I. Pigment Blue 15 series, C.I. Pigment Blue 16, C.I. Pigment Blue 60, C.I. Pigment Blue 80, and combinations thereof.

According to the present disclosure, the yellow pigment component is present in an amount ranging from 0.39 wt % to 0.8 wt %, the red pigment component is present in an amount ranging from 0.1 wt % to 0.5 wt %, and the blue pigment component is present in an amount ranging from 0.03 wt % to 0.20 wt %, based on a total amount of the flexible polymer film 111 as 100 wt %.

According to the present disclosure, the flexible polymer film 111 may have a transparency ranging from 0.01% to 90.00%. In certain embodiments, the flexible polymer film 111 has the transparency ranging from 10% to 25%.

According to the present disclosure, a material of the flexible polymer substrate may be selected from the group consisting of polyvinyl chloride (PVC), polyethylene (PE), polypropylene (PP), acrylonitrile-butadiene-styrene copolymer (ABS), polyethylene terephthalate (PET), polybutylene terephthalate (PBT), nylon, polyurethane (PU), thermoplastic polyolefin (TPO), thermoplastic vulcanizate (TPV), thermoplastic polyester elastomer (TPEE), and combinations thereof.

According to the present disclosure, a material of the metal film 112 may be selected from the group consisting of aluminum (Al), copper (Cu), tin (Sn), silver (Ag), gold (Au), combinations thereof, and pastes containing one or more of the foregoing metals.

According to the present disclosure, a material of the thermoplastic polymer may be polyvinyl chloride (PVC).

According to the present disclosure, the flexible polymer film 111 may have a thickness ranging from 0.1 mm to 2 mm.

According to the present disclosure, the metal film 112 may have a thickness ranging from 0.1 μm to 100 μm. In certain embodiments, the metal film 112 has the thickness ranging from 0.1 μm to 1 μm. In other embodiments, the metal film 112 has the thickness ranging from 10 μm to 50 μm.

### <First Embodiment of Flexible Seat Cushion>

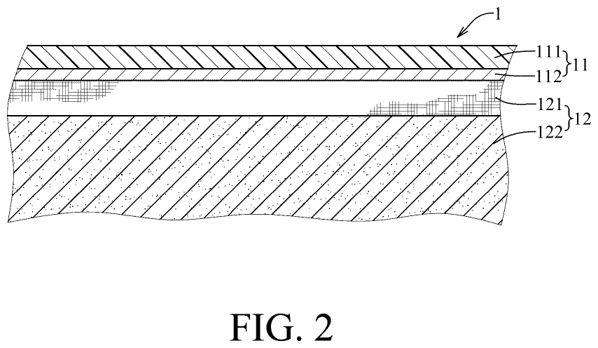

Referring to FIG. 2, a first embodiment of a flexible seat cushion 1 according to the present disclosure includes a foam layer 122, a base fabric 121, and the first embodiment of the flexible composite sheet 11. The base fabric 121 tightly covers a surface of the foam layer 122. A surface of the metal film 112 opposite to the flexible polymer film 111 in the first embodiment of the flexible composite sheet 11 is in intimate contact with a surface of the base fabric 121 opposite to the foam layer 122.

### <Second Embodiment of Flexible Composite Sheet>

A second embodiment of a flexible composite sheet 11 according to the present disclosure includes the same constituents and arrangement as those described in the first embodiment, except that the pigment component of the masterbatch composition in the second embodiment contains a black pigment component in place of the yellow pigment component, the red pigment component, and the blue pigment component used in the first embodiment. To be specific, the black pigment component is selected from the group consisting of Color Index (C.I.) Pigment Black 31, C.I. Pigment Black 32, and a combination thereof.

According to the present disclosure, the pigment component of the masterbatch composition may further include an auxiliary pigment component. In certain embodiments, the auxiliary pigment component is selected from the group consisting of C.I. Pigment Red 122, C.I. Pigment Red 144, C.I. Pigment Red 149, C.I. Pigment Red 166, C.I. Pigment Red 181, C.I. Pigment Red 202, C.I. Pigment Red 214, C.I. Pigment Red 221, C.I. Pigment Red 242, C.I. Pigment Red 254, C.I. Pigment Red 262, C.I. Pigment Orange 43, C.I. Pigment Orange 61, C.I. Pigment Orange 64, C.I. Pigment Orange 68, C.I. Pigment Orange 72, C.I. Pigment Violet 19, C.I. Pigment Violet 37, C.I. Pigment Violet 23, C.I. Pigment Blue 15 series, C.I. Pigment Blue 16, C.I. Pigment Blue 60, C.I. Pigment Blue 80, and combinations thereof.

### <Second Embodiment of Flexible Seat Cushion>

A second embodiment of a flexible seat cushion 1 according to the present disclosure includes the same constituents and arrangement as those described in the first embodiment, except that the first embodiment of the flexible composite sheet 11 is replaced by the second embodiment of the flexible composite sheet 11.

According to the first and the second embodiments of the present disclosure, by virtue of inclusion of the above-mentioned constituents and arrangement, the flexible composite sheet 11 is capable of reflecting infrared radiation or sunlight and reducing heat build-up resulted from absorption of infrared radiation or sunlight, allowing reduction of heat transfer to the foam layer 122 in the flexible seat cushion 1 which includes the flexible composite sheet 11, and thus continuous temperature rise of the flexible seat cushion 1 in an open space (e.g., flexible seat cushions of bicycles, motorcycles, and yachts) can be avoided, and a cooling rate of the flexible seat cushion 1 in an interior space (e.g., flexible seat cushions of vehicles and buses) can be effectively increased without requiring an user to additionally consume energy to lower the temperature of the flexible seat cushion 1.

The disclosure will be further described by way of the following examples. However, it should be understood that the following examples are solely intended for the purpose of illustration and should not be construed as limiting the disclosure in practice.

### EXAMPLES

### Preparation of Flexible Composite Sheet or Flexible Sheet

### Examples 1 to 10 (EX1 to EX10)

The materials and the amounts (based on a total amount of the resultant flexible polymer film 111 as 100 wt %) thereof for preparing a flexible composite sheet 11 (see FIG. 1) of each of EX1 to EX10 are shown in Table 1 below, and procedures for preparing the flexible composite sheet 11 of each of EX1 to EX10 are described as follows. First, a pigment component including specific amounts of a yellow pigment component, a red pigment component, and a blue pigment component (see Table 1 below) was incorporated into crushed polyvinyl chloride (PVC) pellets (serving as a thermoplastic polymer, the pigment component being present in an amount ranging from 20 wt % to 40 wt % based on a total amount of the crushed PVC pellets as 100 wt %) and then were mixed well, followed by conducting an extrusion compounding process using a twin-screw extruder at a temperature ranging from 150° C. to 180° C., so as to obtain a masterbatch composition of each of EX1 to EX10. Next, the masterbatch composition of each of EX1 to EX10 was pelletized and then incorporated and/or loaded into a polyvinyl chloride (PVC) sheet (serving as a flexible polymer substrate and having a thickness of 0.35 mm) for color development, so as to obtain a flexible polymer film 111 (see FIG. 1) of each of EX1 to EX10.

Thereafter, the flexible polymer film 111 of each of EX1 to EX10 was heated to a temperature of 150° C., and then a metal film 112 (see FIG. 1, having a thickness of 0.8 μm, the specific material with reference to Table 1 below) was laminated onto a surface of the flexible polymer film 111 to allow the metal film 112 to be in intimate contact with the surface of the flexible polymer film 111, thereby obtaining the flexible composite sheet 11 of each of EX1 to EX10.

### Examples 11 and 12 (EX11 and EX12)

The procedures and materials for preparing the flexible composite sheets 11 of EX11 and EX12 were similar to those of EX5 and EX10, respectively, except that: with reference to Table 1 below, in EX11, the aluminum foil used in EX5 was replaced by aluminum (serving as a metal film 112); in EX12, the tin foil used in EX10 was replaced by aluminum (serving as a metal film 112); and in EX11 and EX12, a surface of the flexible polymer film 111 of each of EX11 and EX12 thus obtained was subjected to a vacuum metalizing process to allow the aluminum to form an aluminum metalized layer (serving as the metal film 112 and having a thickness of 0.2 μm) and to allow the aluminum metalized layer to be in intimate contact with the surface of the flexible polymer film 111, thereby obtaining the flexible composite sheet 11 of each of EX11 and EX12.

### Examples 13 and 14 (EX13 and EX14)

The procedures and materials for preparing the flexible composite sheets 11 of EX13 and EX14 were similar to those of EX5 and EX10, respectively, except that: with reference to Table 1 below, in EX13, the aluminum foil used in EX5 was replaced by an aluminum paste (serving as a metal film 112 and containing 15% of an aluminum powder with a mean particle size of 600 nm, 37% of a polyvinyl chloride (PVC)/polyvinyl acetate (PVAc) resin, 30% of ethyl acetate (EAc), and 18% of 2-butanone); in EX14, the tin foil used in EX10 was replaced by an aluminum paste (serving as a metal film 112 and containing 15% of an aluminum powder with a mean particle size of 600 nm, 37% of a PVC/PVAc resin, 30% of EAc, and 18% of 2-butanone); and in EX13 and EX14, a surface of the flexible polymer film 111 of each of EX13 and EX14 thus obtained was coated with the aluminum paste to form a coating layer (serving as the metal film 112 and having a thickness ranging from 20 μm to 40 μm) thereon and to allow the coating layer to be in intimate contact with the surface of the flexible polymer film 111, thereby obtaining the flexible composite sheet 11 of each of EX13 and EX14.

### Examples 15 to 17 (EX15 to EX17)

The procedures and materials for preparing the flexible composite sheets 11 of EX15 to EX17 were similar to those of EX2 to EX4, respectively, except that: in each of EX15 to EX17, the pigment component including the yellow pigment component, the red pigment component, and the blue pigment component used in each of EX2 to EX4 was replaced by a pigment component including specific amount(s) (based on a total amount of the resultant flexible polymer film 111 as 100 wt %) of a black pigment component and/or an auxiliary pigment component (see Table 2 below).

### Control Example (Ctrl. EX)

First, 1 wt % to 2 wt % of titanium dioxide (TiO₂) (based on a total amount of the resultant flexible sheet as 100 wt %) was incorporated into crushed PVC pellets (serving as a thermoplastic polymer) and then were mixed well, followed by conducting an extrusion compounding process using the twin-screw extruder at a temperature ranging from 150° C. to 180° C., so as to obtain a TiO₂ masterbatch composition of Ctrl. EX. Next, the TiO₂ masterbatch composition of Ctrl. EX was pelletized and then incorporated and/or loaded into a PVC sheet (serving as a flexible polymer substrate and having a thickness of 0.35 mm) for color development, so as to obtain a flexible sheet of Ctrl. EX.

### Comparative Example (Como. EX)

The procedures and materials for preparing the flexible sheet of Comp. EX were similar to those of Ctrl. EX, except that in Comp. EX, the TiO₂ used in Ctrl. EX was replaced by 0.5 wt % to 1 wt % of carbon black (based on a total amount of the resultant flexible sheet as 100 wt %).

TABLE 1

| | Pigment component | | | |
|---|---|---|---|---|
| Flexible | Yellow | | | |
| composite | pigment | Red pigment | Blue pigment | |
| sheet | component | component | component | Metal film |
| EX1 | C.I. Pigment | C.I. Pigment | C.I. Pigment | Copper foil |
| | Yellow 120 | Red 149 | Blue 60 | |
| | (0.62 wt %) | (0.32 wt %) | (0.12 wt %) | |
| EX2 | C.I. Pigment | C.I. Pigment | C.I. Pigment | Aluminum |
| | Yellow 109 | Red 254 | Blue 60 | foil |
| | (0.52 wt %) | (0.41 wt %) | (0.16 wt %) | |
| EX3 | C.I. Pigment | C.I. Pigment | C.I. Pigment | Tin foil |
| | Yellow 183 | Red 202 | Blue 15:4 | |
| | (0.48 wt %) | (0.37 wt %) | (0.17 wt %) | |
| EX4 | C.I. Pigment | C.I. Pigment | C.I. Pigment | Copper foil |
| | Yellow 214 | Red 242 | Blue 60 | |
| | (0.54 wt %) | (0.38 wt %) | (0.097 wt %) | |
| EX5 | C.I. Pigment | C.I. Pigment | C.I. Pigment | Aluminum |
| | Yellow 138 | Red 262 | Blue 60 | foil |
| | (0.51 wt %) | (0.33 wt %) | (0.095 wt %) | |
| EX6 | C.I. Pigment | C.I. Pigment | C.I. Pigment | Aluminum |
| | Yellow 183 | Red 214 | Blue 15:4 | foil |
| | (0.49 wt %) | (0.32 wt %) | (0.18 wt %) | |
| EX7 | C.I. Pigment | C.I. Pigment | C.I. Pigment | Aluminum |
| | Yellow 109 | Red 202 | Blue 60 | foil |
| | (0.57 wt %) | (0.31 wt %) | (0.13 wt %) | |
| EX8 | C.I. Pigment | C.I. Pigment | C.I. Pigment | Aluminum |
| | Yellow 181 | Red 144 | Blue 60 | foil |
| | (0.55 wt %) | (0.36 wt %) | (0.15 wt %) | |
| EX9 | C.I. Pigment | C.I. Pigment | C.I. Pigment | Aluminum |
| | Yellow 138 | Orange 72 | Blue 15:4 | foil |
| | (0.39 wt %) | (0.42 wt %) | (0.05 wt %) | |
| EX10 | C.I. Pigment | C.I. Pigment | C.I. Pigment | Tin foil |
| | Brown 23 | Violet 37 | Blue 60 | |
| | (0.72 wt %) | (0.15 wt %) | (0.03 wt %) | |
| EX11 | C.I. Pigment | C.I. Pigment | C.I. Pigment | Aluminum |
| | Yellow 138 | Red 262 | Blue 60 | |
| | (0.51 wt %) | (0.33 wt %) | (0.095 wt %) | |
| EX12 | C.I. Pigment | C.I. Pigment | C.I. Pigment | Aluminum |
| | Brown 23 | Violet 37 | Blue 60 | |
| | (0.72 wt %) | (0.15 wt %) | (0.03 wt %) | |
| EX13 | C.I. Pigment | C.I. Pigment | C.I. Pigment | Aluminum |
| | Yellow 138 | Red 262 | Blue 60 | paste |
| | (0.51 wt %) | (0.33 wt %) | (0.095 wt %) | |
| EX14 | C.I. Pigment | C.I. Pigment | C.I. Pigment | Aluminum |
| | Brown 23 | Violet 37 | Blue 60 | paste |
| | (0.72 wt %) | (0.15 wt %) | (0.03 wt %) | |

TABLE 2

| | |
|---|---|
| Flexible | Pigment component |

| composite | Black pigment | Auxiliary pigment | |
|---|---|---|---|
| sheet | component | component | Metal film |
| EX15 | C.I. Pigment | — | Aluminum |
| | Black 31 | | foil |
| | (0.5 wt %) | | |
| EX16 | C.I. Pigment | C.I. Pigment | Tin foil |
| | Black 31 | Red 144 | |
| | (0.48 wt %) | (0.02 wt %) | |
| EX17 | C.I. Pigment | C.I. Pigment | Copper foil |
| | Black 31 | Blue 15:3 | |
| | (0.49 wt %) | (0.01 wt %) | |

### Preparation of Flexible Seat Cushion

### Application Example (AE)

First, a surface of a foam layer 122 was tightly covered by a base fabric 121, so as to obtain a cushion body 12. Next, an adhesive was used to allow a surface of the metal film 112 opposite to the flexible polymer film 111 in the flexible composite sheet 11 of EX7 to be in intimate contact with a surface of the base fabric 121 opposite to the foam layer 122 in the cushion body 12, so as to obtain the flexible seat cushion 1 of AE (see FIG. 2).

### Control Application Example (Ctrl.AE)

The procedures and materials for preparing the flexible seat cushion of Ctrl.AE were similar to those of AE, except that: in Ctrl.AE, the flexible composite sheet 11 of EX7 used in AE was replaced by the flexible sheet of Ctrl. EX.

### Comparative Application Example (Comp. AE)

The procedures and materials for preparing the flexible seat cushion of Comp. AE were similar to those of AE, except that: in Comp. AE, the flexible composite sheet 11 of EX7 used in AE was replaced by the flexible sheet of Comp. EX.

### Property Evaluation and Results

### A. Color Observation and Determination of Transparency

Each of the flexible polymer films 111 of EX1 to EX17 and the flexible sheets of Ctrl. EX and Comp. EX was subjected to color observation with naked eyes and determination of transparency using a sphere benchtop spectrophotometer (manufacturer: X-Rite, Inc., model no.: Ci7800). The results are listed in Table 3 below.

TABLE 3

| | | Color | Transparency |
|---|---|---|---|
| Flexible | EX1 | Black | 13.78% |
| polymer | EX2 | Black | 12.39% |
| film | EX3 | Black | 14.86% |
| | EX4 | Black | 13.47% |
| | EX5 | Black | 15.66% |
| | EX6 | Black | 12.21% |
| | EX7 | Black | 13.55% |
| | EX8 | Black | 11.42% |
| | EX9 | Khaki | 17.25% |
| | EX10 | Dark brown | 20.52% |
| | EX11 | Black | 15.66% |
| | EX12 | Dark brown | 20.52% |
| | EX13 | Black | 15.66% |
| | EX14 | Dark brown | 20.52% |
| | EX15 | Black | 18.64% |
| | EX16 | Dark brown | 19.23% |
| | EX17 | Blue-black | 19.07% |
| Flexible | Ctrl. EX | White | 0% |
| sheet | Comp. EX | Black | 0% |

Referring to Table 3, each of the flexible polymer films 111 of EX1 to EX17 exhibited a dark color and had a transparency ranging from 11.42% to 20.52%. In contrast, the flexible sheets of Ctrl. EX and Comp. EX exhibited white and black colors, respectively, and both had a transparency of 0%.

### B. Infrared-Induced Heat Build-Up Test

A surface of the flexible polymer film 111 opposite to the metal film 112 in the flexible composite sheet 11 of each of EX1 to EX17, a surface of the flexible polymer film 111 alone of each of EX1 to EX17, and a surface of the flexible sheet of each of Ctrl. EX and Comp. EX were subjected to irradiation using an infrared lamp (manufacturer: Philips, model no.: PAR38 IR 150W, a voltage ranging from 125 V to 130V, a wavenumber ranging from 600 nm to 1400 nm) positioned at a distance of 25 cm for a time period of 60 minutes at a temperature of 26° C., followed by measuring temperature thereof using an infrared thermometer. The results are listed in Table 4 below.

TABLE 4

| Flexible | Temper- | | Temper- | | Temper- |
|---|---|---|---|---|---|
| composite | ature | Flexible | ature | Flexible | ature |
| sheet | (° C.) | polymer film | (° C.) | sheet | (° C.) |
| EX1 | 72 | EX1 | 84 | Ctrl. EX | 76 |
| EX2 | 78 | EX2 | 88 | Comp. EX | 112 |
| EX3 | 71 | EX3 | 84 | | |
| EX4 | 73 | EX4 | 86 | | |
| EX5 | 70 | EX5 | 86 | | |
| EX6 | 78 | EX6 | 90 | | |
| EX7 | 72 | EX7 | 88 | | |
| EX8 | 74 | EX8 | 86 | | |
| EX9 | 68 | EX9 | 85 | | |
| EX10 | 64 | EX10 | 83 | | |
| EX11 | 74 | EX11 | 86 | | |
| EX12 | 70 | EX12 | 83 | | |
| EX13 | 78 | EX13 | 86 | | |
| EX14 | 72 | EX14 | 83 | | |
| EX15 | 68 | EX15 | 84 | | |
| EX16 | 70 | EX16 | 85 | | |
| EX17 | 71 | EX17 | 85 | | |

Referring to Table 4, the temperature measured in the flexible composite sheet 11 of each of EX1 to EX17 was not greater than 78° C., which was substantially lower than the 83° C. to 90° C. measured in the flexible polymer film 111 alone of each of EX1 to EX17, and was comparable to or even lower than the 76° C. measured in the flexible sheet of Ctrl. EX. In contrast, the temperature measured in the flexible sheet of Comp. EX was up to 112° C., indicating that the flexible sheet of Comp. EX exhibited a pronounced temperature rise. These results demonstrate that the flexible composite sheet 11 of the present disclosure (i.e., the flexible composite sheets 11 of EX1 to EX17) is capable of reducing heat build-up resulted from absorption of infrared radiation.

### C. Sunlight-Induced Heat Build-Up Test

At 11:00 a.m. (with ambient temperature of approximately 37° C.), a surface of the flexible polymer film 111 opposite to the metal film 112 in the flexible composite sheet 11 of each of EX1 to EX10 and EX15 to EX17, a surface of the flexible polymer film 111 alone of each of EX1 to EX10 and EX15 to EX17, and a surface of the flexible sheet of each of Ctrl. EX and Comp. EX were exposed to direct sunlight outdoors for a time period of 60 minutes, followed by measuring temperature thereof using the infrared thermometer. The results are listed in Table 5 below.

TABLE 5

| Flexible | Temper- | | Temper- | | Temper- |
|---|---|---|---|---|---|
| composite | ature | Flexible | ature | Flexible | ature |
| sheet | (° C.) | polymer film | (° C.) | sheet | (° C.) |
| EX1 | 49 | EX1 | 60 | Ctrl. EX | 51 |
| EX2 | 52 | EX2 | 64 | Comp. EX | 83 |
| EX3 | 48 | EX3 | 59 | | |
| EX4 | 50 | EX4 | 61 | | |
| EX5 | 48 | EX5 | 61 | | |
| EX6 | 52 | EX6 | 63 | | |
| EX7 | 47 | EX7 | 60 | | |
| EX8 | 51 | EX8 | 62 | | |
| EX9 | 44 | EX9 | 56 | | |
| EX10 | 45 | EX10 | 57 | | |
| EX15 | 48 | EX15 | 61 | | |
| EX16 | 50 | EX16 | 62 | | |
| EX17 | 51 | EX17 | 62 | | |

Referring to FIG. 5, the temperature measured in the flexible composite sheet 11 of each of EX1 to EX10 and EX15 to EX17 was not greater than 52° C., which was substantially lower than the 56° C. to 64° C. measured in the flexible polymer film 111 alone of each of EX1 to EX10 and EX15 to EX17, and was comparable to or even lower than the 51° C. measured in the flexible sheet of Ctrl. EX. In contrast, the temperature measured in the flexible sheet of Comp. EX was up to 83° C., indicating that the flexible sheet of Comp. EX exhibited a pronounced temperature rise. These results demonstrate that the flexible composite sheet 11 of the present disclosure (i.e., the flexible composite sheets 11 of EX1 to EX10 and EX15 to EX17) is capable of reducing heat build-up resulted from sunlight exposure.

### D. Vehicle Interior Cooling Test

From 10:00 a.m. to 12:00 p.m. (with ambient temperature of approximately 36° C.), the flexible seat cushion of each of AE, Ctrl. AE, and Comp. AE (in which the flexible polymer film 111 of AE and the flexible sheets of Ctrl. AE and Comp. AE faced upward, and the foam layers of AE, Ctrl. AE, and Comp. AE faced downward) was placed inside a vehicle with all windows closed and the air conditioner turned off for a time period of 120 minutes, during which the temperature increased to approximately 72° C. Thereafter, all windows were fully opened and the air conditioner was turned on to allow maximum fan speed at a temperature of 18° C., followed by measuring temperature of the flexible seat cushion every 30 seconds using the infrared thermometer. The results are listed in Table 6 below.

TABLE 6

| Time point | | 0 s | 30 s | 60 s | 90 s | 120 s | 150 s | 180 s |
|---|---|---|---|---|---|---|---|---|
| Temperature | AE | 72° C. | 65° C. | 56° C. | 49° C. | 48° C. | 46° C. | 44° C. |
| of flexible | Ctrl. | 72° C. | 64° C. | 54° C. | 46° C. | 45° C. | 44° C. | 42° C. |
| seat cushion | AE | | | | | | | |
| | Comp. | 72° C. | 67° C. | 59° C. | 55° C. | 53° C. | 51° C. | 50° C. |
| | AE | | | | | | | |

Referring to Table 6, the cooling rate of the flexible seat cushion 1 of AE was comparable to that of the flexible seat cushion of Ctrl. AE, with both flexible seat cushions exhibiting a temperature decrease to below 50° C. within 90 seconds and to below 45° C. within 180 seconds. In contrast, the flexible seat cushion of Comp. AE exhibited a temperature decrease merely to approximately 55° C. within 90 seconds and merely to approximately 50° C. within 180 seconds, indicating that the cooling rate thereof was relatively low. These results demonstrate that a cooling rate of the flexible seat cushion 1 of the present disclosure (i.e., the flexible seat cushion 1 of AE) exhibits an effectively increased cooling rate in an interior space.

Summarizing the above test results, it is clear that by virtue of inclusion of the above-mentioned constituents and arrangement, the flexible composite sheet 11 according to the present disclosure is capable of reflecting infrared radiation or sunlight and reducing heat build-up resulted from absorption of infrared radiation or sunlight, allowing reduction of heat transfer to the foam layer 122 in the flexible seat cushion 1 which includes the flexible composite sheet 11, and thus continuous temperature rise of the flexible seat cushion 1 in an open space (e.g., flexible seat cushions of bicycles, motorcycles, and yachts) can be avoided, and a cooling rate of the flexible seat cushion 1 in an interior space (e.g., flexible seat cushions of vehicles and buses) can be effectively increased without requiring an user to additionally consume energy to lower the temperature of the flexible seat cushion 1.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A flexible composite sheet, comprising:
a flexible polymer film which is obtained by loading a masterbatch composition to develop color in a flexible polymer substrate, the masterbatch composition including
a thermoplastic polymer,
a yellow pigment component selected from the group consisting of Color Index (C.I.) Pigment Yellow 81, C.I. Pigment Yellow 83, C.I. Pigment Yellow 109, C.I. Pigment Yellow 110, C.I. Pigment Yellow 120, C.I. Pigment Yellow 128, C.I. Pigment Yellow 138, C.I. Pigment Yellow 147, C.I. Pigment Yellow 181, C.I. Pigment Yellow 183, C.I. Pigment Yellow 214, C.I. Pigment Brown 23, and combinations thereof,
a red pigment component selected from the group consisting of C.I. Pigment Red 122, C.I. Pigment Red 144, C.I. Pigment Red 149, C.I. Pigment Red 166, C.I. Pigment Red 181, C.I. Pigment Red 202, C.I. Pigment Red 214, C.I. Pigment Red 221, C.I. Pigment Red 242, C.I. Pigment Red 254, C.I. Pigment Red 262, C.I. Pigment Orange 43, C.I. Pigment Orange 61, C.I. Pigment Orange 64, C.I. Pigment Orange 68, C.I. Pigment Orange 72, C.I. Pigment Violet 19, C.I. Pigment Violet 37, C.I. Pigment Violet 23, and combinations thereof, and
a blue pigment component selected from the group consisting of C.I. Pigment Blue 15 series, C.I. Pigment Blue 16, C.I. Pigment Blue 60, C.I. Pigment Blue 80, and combinations thereof; and
a metal film which is in intimate contact with a surface of the flexible polymer film;
the flexible composite sheet having low heat build-up property.

2. The flexible composite sheet as claimed in claim 1, wherein the flexible polymer film has a transparency ranging from 0.01% to 90.00%.

3. The flexible composite sheet as claimed in claim 2, wherein the flexible polymer film has the transparency ranging from 10% to 25%.

4. The flexible composite sheet as claimed in claim 1, wherein the yellow pigment component is present in an amount ranging from 0.39 wt % to 0.8 wt %, the red pigment component is present in an amount ranging from 0.1 wt % to 0.5 wt %, and the blue pigment component is present in an amount ranging from 0.03 wt % to 0.20 wt %, based on a total amount of the flexible polymer film as 100 wt %.

5. The flexible composite sheet as claimed in claim 1, wherein a material of the flexible polymer substrate is selected from the group consisting of polyvinyl chloride (PVC), polyethylene (PE), polypropylene (PP), acrylonitrile-butadiene-styrene copolymer (ABS), polyethylene terephthalate (PET), polybutylene terephthalate (PBT), nylon, polyurethane (PU), thermoplastic polyolefin (TPO), thermoplastic vulcanizate (TPV), thermoplastic polyester elastomer (TPEE), and combinations thereof.

6. The flexible composite sheet as claimed in claim 1, wherein a material of the metal film is selected from the group consisting of aluminum (Al), copper (Cu), tin (Sn), silver (Ag), gold (Au), combinations thereof, and pastes containing one or more of the foregoing metals.

7. The flexible composite sheet as claimed in claim 1, wherein a material of the thermoplastic polymer is polyvinyl chloride (PVC).

8. The flexible composite sheet as claimed in claim 1, wherein the flexible polymer film has a thickness ranging from 0.1 mm to 2 mm.

9. The flexible composite sheet as claimed in claim 1, wherein the metal film has a thickness ranging from 0.1 μm to 100 μm.

10. The flexible composite sheet as claimed in claim 9, wherein the metal film has the thickness ranging from 0.1 μm to 1 μm.

11. A flexible seat cushion, comprising:
a foam layer;
a base fabric which tightly covers a surface of the foam layer; and
the flexible composite sheet as claimed in claim 1, a surface of the metal film opposite to the flexible polymer film in the flexible composite sheet being in intimate contact with a surface of the base fabric opposite to the foam layer.

12. A flexible composite sheet, comprising:
a flexible polymer film which is obtained by loading a masterbatch composition to develop color in a flexible polymer substrate, the masterbatch composition including
a thermoplastic polymer, and
a black pigment component selected from the group consisting of Color Index (C.I.) Pigment Black 31, C.I. Pigment Black 32, and a combination thereof; and
a metal film which is in intimate contact with a surface of the flexible polymer film;
the flexible composite sheet having low heat build-up property.

13. The flexible composite sheet as claimed in claim 12, wherein the flexible polymer film has a transparency ranging from 0.01% to 90.00%.

14. The flexible composite sheet as claimed in claim 13, wherein the flexible polymer film has the transparency ranging from 10% to 25%.

15. The flexible composite sheet as claimed in claim 12, wherein the masterbatch composition further includes an auxiliary pigment component which is selected from the group consisting of C.I. Pigment Red 122, C.I. Pigment Red 144, C.I. Pigment Red 149, C.I. Pigment Red 166, C.I. Pigment Red 181, C.I. Pigment Red 202, C.I. Pigment Red 214, C.I. Pigment Red 221, C.I. Pigment Red 242, C.I. Pigment Red 254, C.I. Pigment Red 262, C.I. Pigment Orange 43, C.I. Pigment Orange 61, C.I. Pigment Orange 64, C.I. Pigment Orange 68, C.I. Pigment Orange 72, C.I. Pigment Violet 19, C.I. Pigment Violet 37, C.I. Pigment Violet 23, C.I. Pigment Blue 15 series, C.I. Pigment Blue 16, C.I. Pigment Blue 60, C.I. Pigment Blue 80, and combinations thereof.

16. The flexible composite sheet as claimed in claim 12, wherein a material of the flexible polymer substrate is selected from the group consisting of polyvinyl chloride (PVC), polyethylene (PE), polypropylene (PP), acrylonitrile-butadiene-styrene copolymer (ABS), polyethylene terephthalate (PET), polybutylene terephthalate (PBT), nylon, polyurethane (PU), thermoplastic polyolefin (TPO), thermoplastic vulcanizate (TPV), thermoplastic polyester elastomer (TPEE), and combinations thereof.

17. The flexible composite sheet as claimed in claim 12, wherein a material of the metal film is selected from the group consisting of aluminum (Al), copper (Cu), tin (Sn), silver (Ag), gold (Au), combinations thereof, and pastes containing one or more of the foregoing metals.

18. The flexible composite sheet as claimed in claim 12, wherein a material of the thermoplastic polymer is polyvinyl chloride (PVC).

19. The flexible composite sheet as claimed in claim 12, wherein the flexible polymer film has a thickness ranging from 0.1 mm to 2 mm.

20. The flexible composite sheet as claimed in claim 12, wherein the metal film has a thickness ranging from 0.1 μm to 100 μm.

21. The flexible composite sheet as claimed in claim 20, wherein the metal film has the thickness ranging from 0.1 μm to 1 μm.

22. A flexible seat cushion, comprising:
a foam layer;
a base fabric which tightly covers a surface of the foam layer; and
the flexible composite sheet as claimed in claim 12, a surface of the metal film opposite to the flexible polymer film in the flexible composite sheet being in intimate contact with a surface of the base fabric opposite to the foam layer.
